(19) United States
(12) Patent Application Publication
(10) Pub. No.: US 2003/0123367 A1
(43) Pub. Date: Jul. 3, 2003

(54) High-speed optical disc driver

(76) Inventors: Chun-Liang Lai, Taipei (TW); Chao-Ching Fang, Taipei (TW)

Correspondence Address: BIRCH STEWART KOLASCH & BIRCH, PO BOX 747, FALLS CHURCH, VA, 22040-0747, US

(21) Appl. No.: 10/315,136

(22) Filed: Dec. 10, 2002

(30) Foreign Application Priority Data
Dec. 31, 2001 (TW) 090224327

(51) Int. Cl. G11B 33/02

(52) U.S. Cl. 369/77.1

(57) ABSTRACT

A high-speed optical disc driver. The optical disc driver holds an optical disc, and comprises a housing, a frame, a tray, and a protrusion. The frame is disposed in the housing. The tray is disposed on the frame in a moveable manner, and the optical disc is disposed on the tray. The protrusion is disposed on a surface of the housing, facing the tray, to adjust pressure distribution surrounding the optical disc. Thus, the optical disc is stably disposed on the tray so that noise generated from the optical disc driver is minimized.

### BACKGROUND OF THE INVENTION

1. Field of the Invention

The invention relates to a high-speed optical disc driver; in particular, an optical disc driver that can keep an optical disc, disposed therein, rotating in a stable condition.

2. Description of the Related Art

Referring to FIG. 1 showing an exploded view of a conventional optical disc driver 10, the optical disc driver 10 includes a tray 11, a frame 12, and a housing 13. The tray 11 is disposed on the frame 12 in a moveable manner, and supports an optical disc (not shown). The housing 13 encases the tray 11 and the frame 12. In addition, the optical disc driver 10 further comprises an optical pickup, several motors, and other elements. Since such devices are not directly related to this invention, their detailed description is omitted.

Recently, the rotation speed of the optical disc driver has increased based on the user requirements. However, an optical disc, disposed in the high-speed optical disc driver, often rotates in an unstable condition due to the arrangement of the conventional high-speed optical disc driver. Specifically, when the optical disc is disposed on the tray of the optical disc driver, the distance between the optical disc and the nearest portion to an upper surface of the optical disc of the optical disc driver is different from the distance between the optical disc and the nearest portion to a lower surface of the optical disc of the optical disc driver. Thus, there is a pressure differential beyond the optical disc and below the optical disc. As a result, the optical disc is easily tilted and floated during rotation. Furthermore, when a shaft of the motor of the optical disc driver cannot resist the floating force of the optical disc, the motor generates noise. In addition, since there is a large pressure differential beyond the optical disc and below the optical disc, the optical disc undergoes excessive bending moment. As a result, the optical disc is easily broken.

### SUMMARY OF THE INVENTION

In order to address the disadvantages of the aforementioned optical disc driver, the invention provides a high-speed optical disc driver that can keep an optical disc rotating stably when disposed in the optical disc driver.

Accordingly, the invention provides an optical disc driver. The optical disc driver holds an optical disc, and comprises a housing, a frame, a tray, and a first protrusion. The frame is disposed in the housing. The tray is disposed on the frame in a moveable manner, and the optical disc is disposed on the tray. The first protrusion is disposed on a surface, facing the tray, of the housing, to adjust pressure distribution surrounding the optical disc. Thus, the optical disc is stably disposed on the tray so that noise generated from the optical disc driver is minimized.

In a preferred embodiment, the first protrusion faces the optical disc disposed on the tray.

In another preferred embodiment, the first protrusion is integrally formed on the housing by pressing or injection molding.

In another preferred embodiment, the first protrusion is disposed on the housing by adhesive.

In another preferred embodiment, the optical disc driver further comprises a second protrusion disposed on the tray.

In another preferred embodiment, the first protrusion is a rectangular parallelepiped comprising a first, second, and third edge.

Furthermore, the first edge is substantially normal to a tangential direction of an edge of the optical disc, and the first edge is 10 mm to 70 mm long. The second edge is substantially parallel to a tangential direction of an edge of the optical disc, and the second edge is 3 mm to 20 mm long. The third edge is 1 mm to 5 mm long.

In another preferred embodiment, a portion of the first protrusion, adjacent to the housing, is rounded.

In another preferred embodiment, a cross section of the first protrusion is trapezoid, triangular, round, or oval.

In another preferred embodiment, the first protrusion is L-shaped.

Furthermore, the invention provides another optical disc driver. The optical disc driver holds an optical disc, and comprises a housing, a frame, a tray, and a portion. The frame is disposed in the housing. The tray is disposed on the frame in a moveable manner, and the optical disc is disposed on the tray. The portion is disposed on a surface, facing the tray, of the housing to adjust pressure distribution surrounding the optical disc. Thus, the optical disc is stably disposed on the tray so that noise generated from the optical disc driver is minimized.

### BRIEF DESCRIPTION OF THE DRAWINGS

The invention is hereinafter described in detail with reference to the accompanying drawings in which:

FIG. 1 is an exploded view of a conventional optical disc driver;

FIG. 2A is a schematic view showing pressure distribution in fluid field without a protrusion;

FIG. 2B is a schematic view showing pressure distribution in fluid field with a protrusion;

FIG. 3A is an exploded view of an optical disc driver as disclosed in this invention;

FIG. 3B is a schematic view of the assembled optical disc driver in FIG. 3A;

FIG. 4 is a schematic view of an embodiment of a protrusion in FIG. 3A;

FIG. 5 is another schematic view of the protrusion in FIG. 4;

FIG. 6A is a schematic view of another embodiment of the protrusion;

FIG. 6B is another schematic view of the protrusion in FIG. 6A; and

FIG. 7 and FIG. 8 and FIG. 9 are schematic views of variant embodiments of the protrusion.

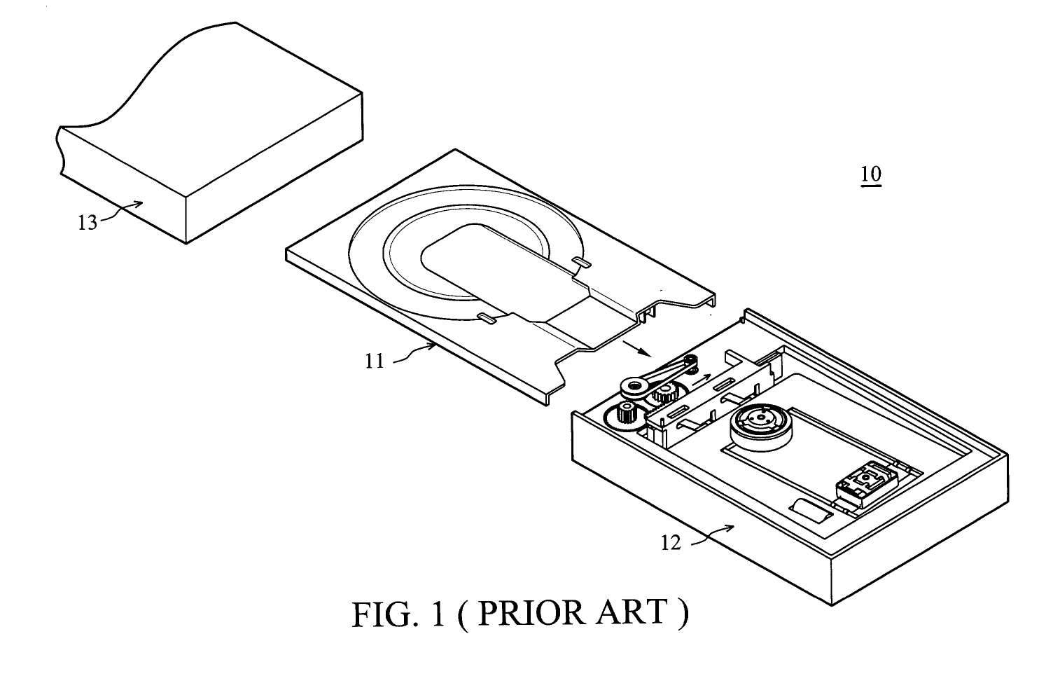

### DETAILED DESCRIPTION OF THE INVENTION

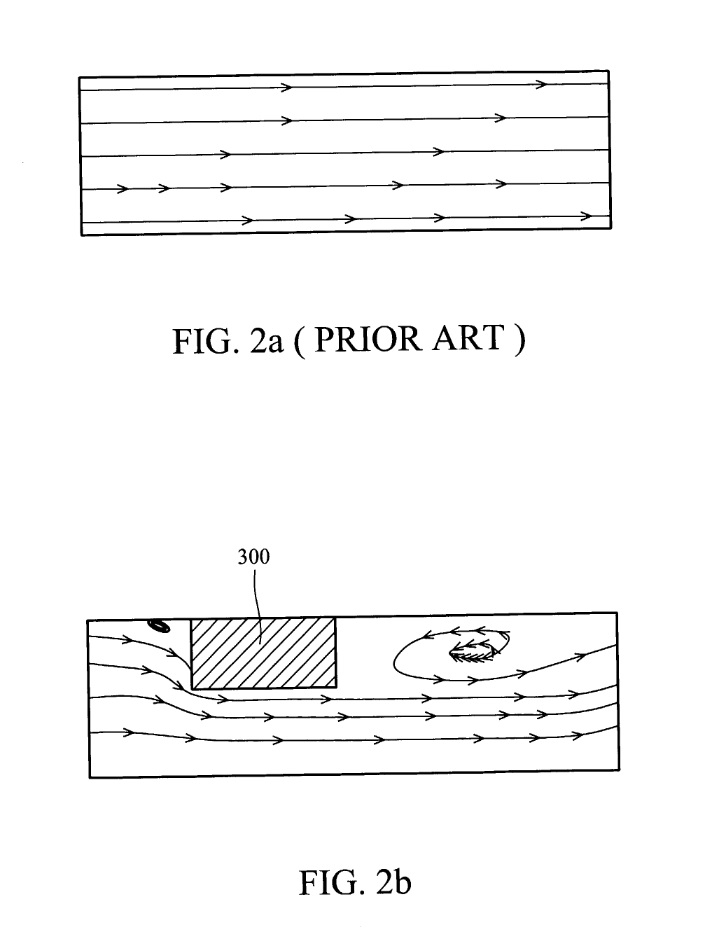

FIG. 2A is a schematic view that shows pressure distribution in fluid field without a protrusion, and FIG. 2B is a schematic view that shows pressure distribution in fluid field with a protrusion 300. In FIG. 2A, there is no protrusion in the fluid field so that fluid flows smoothly in the fluid field. Thus, the pressure distribution in the fluid field is very uniform. In contrast, there is a protrusion 300 in the fluid field in FIG. 2B, such that when fluid flows around the protrusion 300, the protrusion 300 changes the direction of the flow. At the same time, the pressure of the area confronting the protrusion 300 is higher than that of the opposing area. As a result, the pressure distribution in the fluid field as shown in FIG. 2B is not uniform, and an object, disposed in this fluid field as shown in FIG. 2B, is subjected to an uneven force.

Specifically, when an optical disc is disposed on a tray of a conventional optical disc driver, the distance between the optical disc and the nearest portion to an upper surface of the optical disc of the optical disc driver is different from the distance between the optical disc and the nearest portion to an lower surface of the optical disc of the optical disc driver. Thus, there is a pressure differential beyond the optical disc and below the optical disc. Also, both the pressure beyond the optical disc and the pressure below the optical disc are uniform as shown in FIG. 2A so that the pressure beyond the optical disc is uniformly smaller than the pressure below the optical disc. As a result, the optical disc is easily tilted and floated during rotation. To prevent the optical disc from floating, the pressure beyond the optical disc must be uneven as shown in FIG. 2B so that the pressure beyond the optical disc is not drastically less than the pressure below the optical disc.

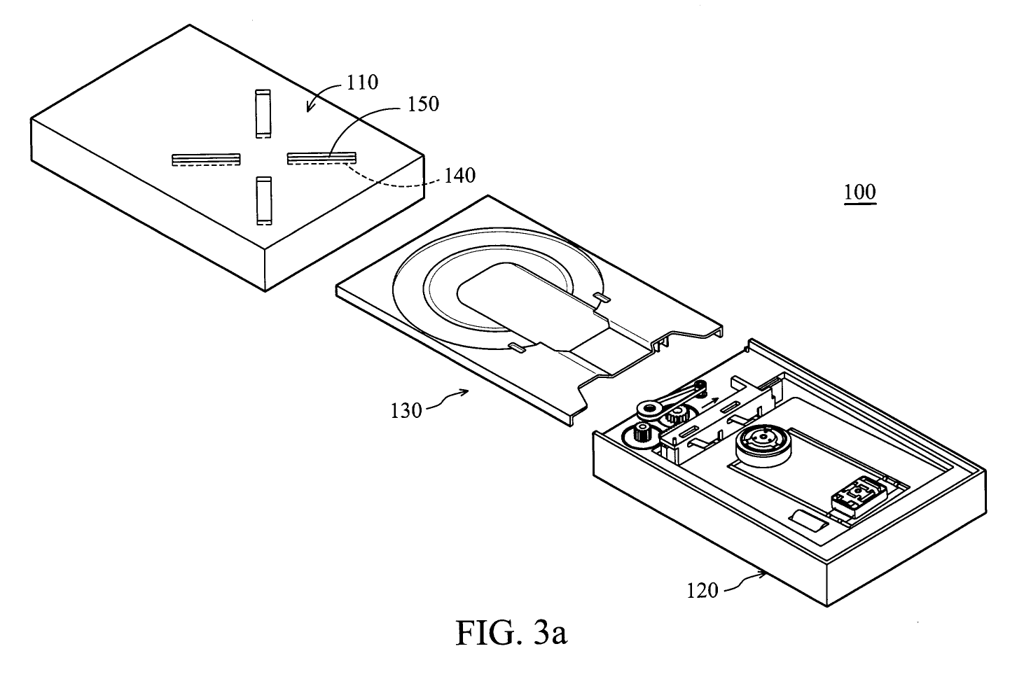

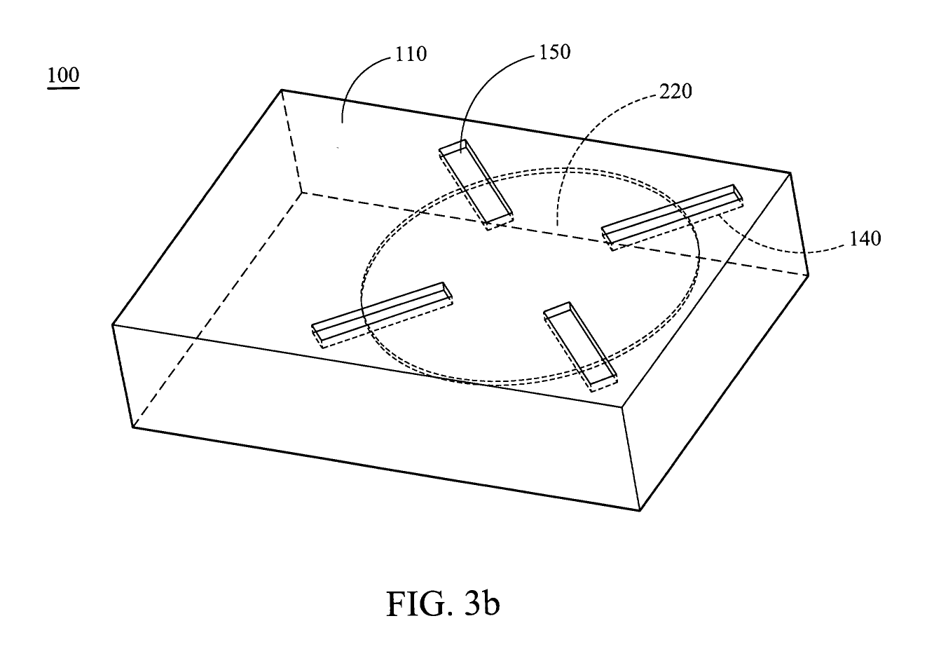

An optical disc driver 100 as disclosed in this invention is designed based on the above concept. Referring to FIG. 3A and FIG. 3B, the optical disc driver 100 holds an optical disc 220, and comprises a housing 110, a frame 120, a tray 130, and four protrusions 140. The housing 110 encases units inside the optical disc driver 100. The frame 120 is disposed in the housing 110, and supports the other units of the optical disc driver 100. The tray 130 is disposed on the frame 120 in a moveable manner, and the optical disc 220 is disposed on the tray 130.

The protrusion 140 is disposed on a top portion, facing the optical disc 220, of the housing 110 to adjust pressure distribution surrounding the optical disc 220. Specifically, since there is a protrusion 140 beyond the optical disc, the pressure beyond the optical disc 220 is not drastically less than the pressure below the optical disc 220. Thus, the optical disc 220 can be prevented from floating during rotation, and stably disposed on the tray 130. As a result, noise generated from the optical disc driver 100 is minimized.

It is noted that the location of the protrusion 140 is not limited as long as it can change the pressure distribution surrounding the optical disc 220 to prevent the optical disc 220 from floating. For example, the protrusions 140 can be disposed on the other portions of the housing 110, or/and on the frame 120, or/and over the tray 130. Generally, the protrusions 140 are preferably formed near an exit, for the tray 130, of the housing 110.

In addition, the number of the protrusions 140 is also not limited to four, and the protrusions 140 are not required to be symmetrical.

Furthermore, the housing does not require the protrusions as long as pressure distribution can be adjusted. Specifically, other types of irregularly formed portions can replace the protrusions, such as holes, cavities and others.

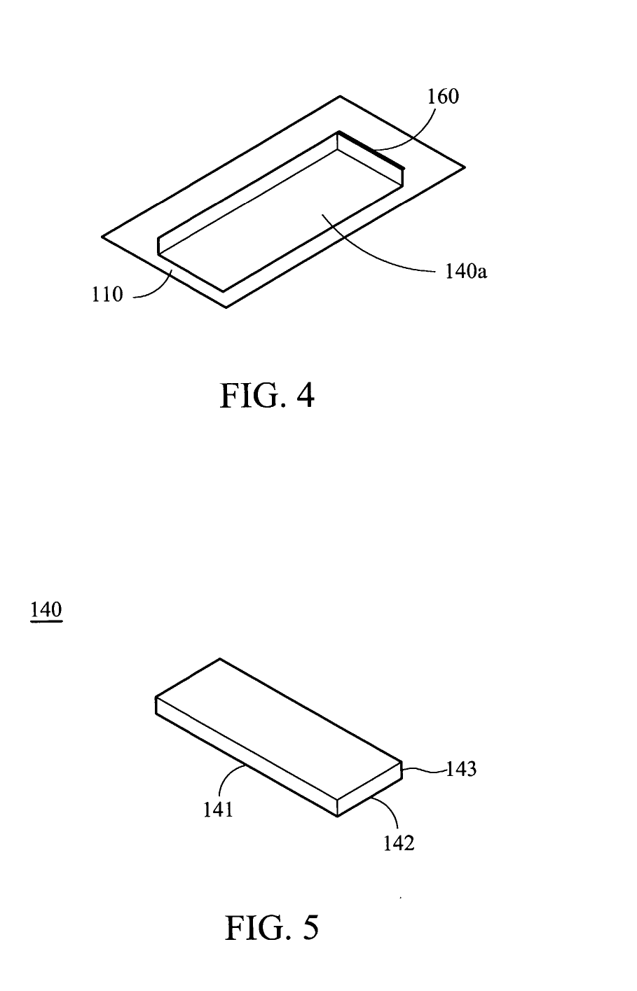

Referring to FIG. 3B, concave portions 150 can be integrally formed on the housing 110 by pressing to integrally form the protrusions 140. However, the forming manner of the protrusions 140 is not limited thereto. For example, the protrusions 140 can be integrally formed on the housing 110 by injection molding, or, as shown in FIG. 4, a protrusion 140a can be disposed on the housing 110 by adhesive 160.

The protrusion 140 can be a rectangular parallelepiped comprising a first edge 141, a second edge 142 and a third edge 143, as shown in FIG. 5. The first edge 141 of the protrusion 140 is substantially normal to a tangential direction of an edge of the optical disc 220 disposed on the tray 130; that is, the first edge 141 is substantially normal to direction of flowing air generated by the rotating optical disc 220. The first edge has preferably length of 10 mm to 70 mm. The second edge 142 of the protrusion 140 is substantially parallel to a tangential direction of an edge of the optical disc 220, and the second edge 142 has preferably length of 3 mm to 20 mm. The third edge 143 has preferably length of 1 mm to 5 mm.

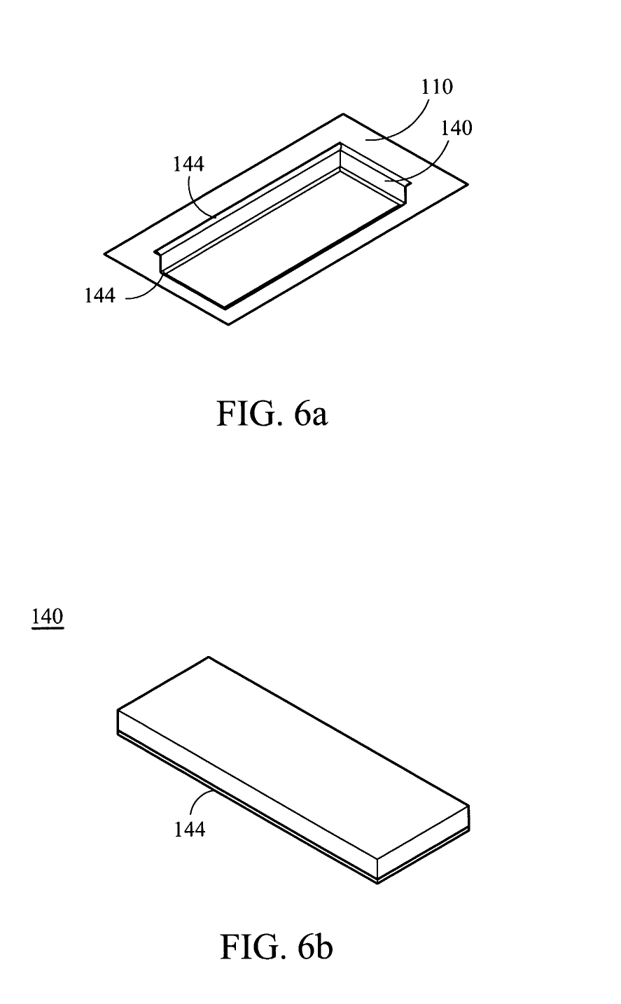

Referring to FIG. 6A and FIG. 6B, a portion, adjacent to the housing 110, of the protrusion 140 is rounded. That is, the portions adjacent to the first edge 141, the second edge 142, and the third edge 143 are rounded to form rounded edges 144.

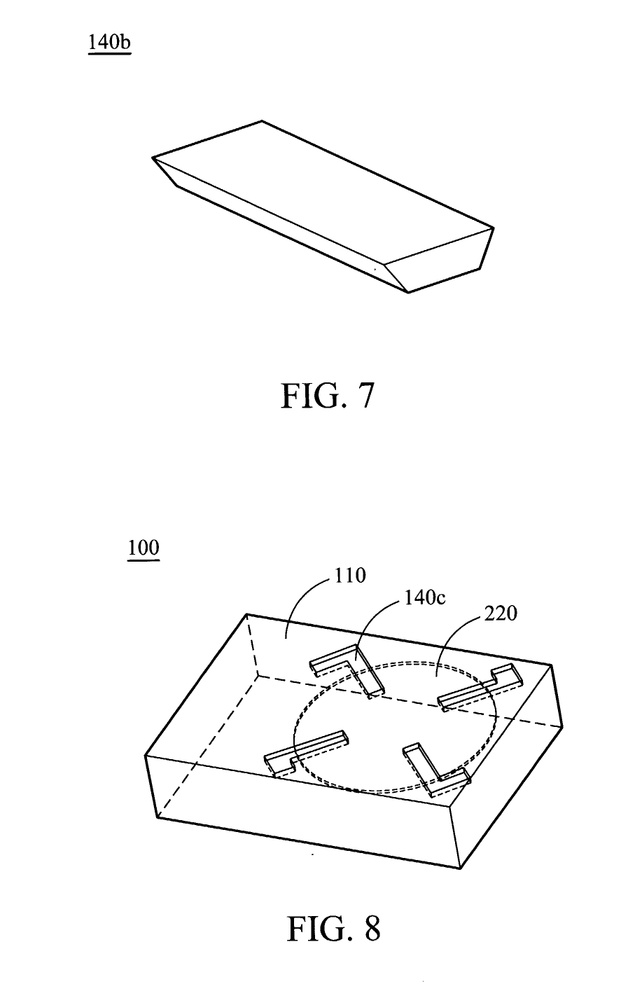

In addition, the cross section of the protrusion 140 is not limited. For example, a cross section of the protrusion 140 can be trapezoid as shown in FIG. 7. Furthermore, a cross section of the protrusion 140 can also be triangular, round, or oval.

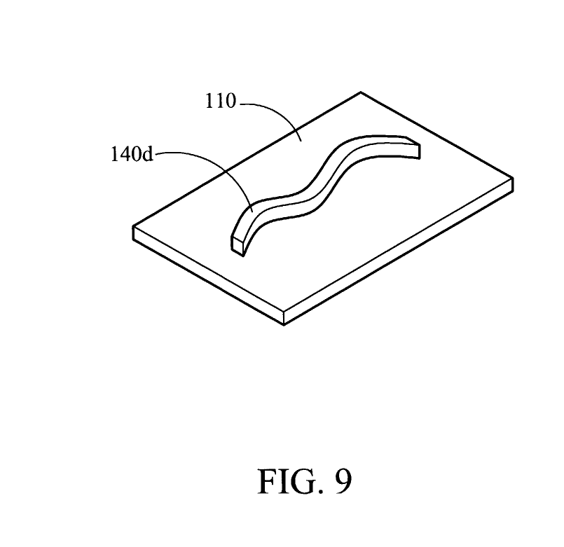

Furthermore, the housing 110 may be provided with L-shaped protrusions 140c as shown in FIG. 8, or an irregularly shaped protrusion 140d as shown in FIG. 9.

As stated above, since the housing or/and the tray are provided with the protrusions, the pressure distribution surrounding the optical disc, disposed in the optical disc driver, can be changed. Specifically, since the pressure beyond the optical disc is not uniform, the pressure beyond the optical disc is not drastically less than the pressure below the optical disc. Thus, the optical disc is prevented from floating, and the force subjected by the optical disc can be reduced. As a result, noise generated from the optical disc driver is minimized, and the optical disc is less easily broken.

In addition, since the protrusion can be formed on the housing by pressing, the cost of the optical disc driver is low.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. An optical disc driver, for holding an optical disc, comprising:
a housing;
a frame disposed in the housing;
a tray, disposed on the frame in a moveable manner, for the optical disc to dispose thereon; and
a first protrusion disposed on a surface, facing the tray, of the housing to adjust pressure distribution surrounding the optical disc.

2. The optical disc driver as claimed in claim 1, wherein the first protrusion is integrally formed on the housing.

3. The optical disc driver as claimed in claim 1, further comprising:
a second protrusion disposed over the tray.

4. The optical disc driver as claimed in claim 1, wherein the first protrusion is a rectangular parallelepiped comprising a first, second, and third edge.

5. The optical disc driver as claimed in claim 4, wherein the first edge is substantially normal to a tangential direction of an edge of the optical disc, and the first edge has length of 10 mm to 70 mm.

6. The optical disc driver as claimed in claim 4, wherein the second edge is substantially parallel to a tangential direction of an edge of the optical disc, and the second edge has length of 3 mm to 20 mm.

7. The optical disc driver as claimed in claim 4, wherein the third edge has length of 1 mm to 5 mm.

8. The optical disc driver as claimed in claim 1, wherein a portion of the first protrusion, adjacent to the housing, has rounded edge.

9. The optical disc driver as claimed in claim 1, wherein the cross section of the first protrusion is chosen from the group consisting of trapezoid, triangular, round and oval.

10. The optical disc driver as claimed in claim 1, wherein the first protrusion is L-shaped.

11. An optical disc driver, for holding an optical disc, comprising:
a housing;
a frame disposed in the housing;
a tray, disposed on the frame in a moveable manner, for the optical disc to dispose thereon; and
a first protrusion formed over the tray to adjust pressure distribution surrounding the optical disc.

12. The optical disc driver as claimed in claim 11, further comprising:
a second protrusion disposed on a surface, facing the optical disc disposed on the tray, of the housing.

13. The optical disc driver as claimed in claim 12, wherein the second protrusion is integrally formed on the housing.

14. The optical disc driver as claimed in claim 11, wherein the first protrusion is a rectangular parallelepiped comprising a first, second, and third edge.

15. The optical disc driver as claimed in claim 14, wherein the first edge is substantially normal to a tangential direction of an edge of the optical disc, and the first edge has length of 10 mm to 70 mm.

16. The optical disc driver as claimed in claim 14, wherein the second edge is substantially parallel to a tangential direction of an edge of the optical disc, and the second edge has length of 3 mm to 20 mm.

17. The optical disc driver as claimed in claim 14, wherein the third edge has length of 1 mm to 5 mm.

18. The optical disc driver as claimed in claim 11, wherein a portion, adjacent to the tray, of the first protrusion has rounded edge.

19. The optical disc driver as claimed in claim 11, a cross section of the first protrusion is chosen from the group consisting of trapezoid, triangular, round and oval.

20. The optical disc driver as claimed in claim 11, wherein the first protrusion is L-shaped.
